(19) United States
(12) Patent Application Publication
(10) Pub. No.: US 2006/0243088 A1
(43) Pub. Date: Nov. 2, 2006

(54) Telescoping steering shaft

(75) Inventors: William D. Cymbal, Freeland, MI (US); Richard K. Riefe, Saginaw, MI (US)

Correspondence Address: DELPHI TECHNOLOGIES, INC., M/C 480-410-202, PO BOX 5052, TROY, MI, 48007, US

(73) Assignee: Delphi Technologies, Inc., Troy, MI (US)

(21) Appl. No.: 11/116,519

(22) Filed: Apr. 28, 2005

(51) Int. Cl. B62D 1/16; B62D 1/18

(52) U.S. Cl. 74/492; 280/775

(57) ABSTRACT

A telescopically adjustable vehicular steering column assembly (16) includes an upper steering shaft (18, 118) operatively coupled to a lower steering shaft (20, 120). The lower steering shaft (20, 120) is fitted with a guide head (32, 132) which is precision machined to slide within a receiving chamber (28, 128) in the upper steering shaft (18, 188). An axially extending keyway (40, 140) is formed in either the guide head (32) or in the receiving chamber (128) for sliding registry with a key (44, 144). The guide head (32, 132) is affixed to the end of the lower steering shaft (20, 120) through a sheer member (35) which is created by injecting a fluidic plastic material (35) through injection ports (34) so that the plastic forms in injection grooves (36). Once solidified, the plastic material (35) securely affixes the guide head (32, 132) in an operative position on the end of the lower steering shaft (20, 120). However, in the event of a catastrophic collision, the plastic material (35) will sheer, allowing the lower steering shaft (20, 120) to translate into an upper tubular section (22, 122) of the upper steering shaft (18, 118).

### FIELD OF THE INVENTION

The invention relates to a telescopically adjustable shaft for a vehicular steering column assembly.

### BACKGROUND OF THE INVENTION

Many vehicles, and automobiles in particular, are provided with a steering column assembly in which the upper portion, which carries the steering wheel, is arranged for longitudinal adjustment to enable selective telescopic positioning of the steering wheel through a limited range. This arrangement has been found to be exceptionally advantageous in accommodating vehicle operators of varying stature. However, there is a desire to provide such a telescoping steering shaft assembly that is less costly but at the same time strong and exhibits good telescoping loads.

Current production designs of telescoping steering shafts employing multi-tooth splines. A tubular female sleeve surrounds the splined shaft with a plastic over-molded feature there between. Although these current designs are reliable and effective, they are expensive to produce and require a high degree of manufacturing complexity. Additionally, acceptable telescoping loads are difficult to achieve and maintain.

### SUMMARY OF THE INVENTION AND ADVANTAGES

A telescopically adjustable vehicular steering column assembly is provided for transmitting rotary motion from a steering wheel to a steered element, such as the front wheels in the example of an automobile. The column assembly comprises an upper steering shaft defining a longitudinal axis and operatively connected to either the steering wheel or the steered element. The upper steering shaft includes a lower tubular section which presents an axially extending receiving chamber. A lower steering shaft is operatively connected to the other of either the steering wheel or the steered element, and includes a guide head fixed thereto and axially slideably disposed within the receiving chamber of the lower tubular section. An axially extending keyway is formed in either the guide head or the receiving chamber with a key fixed to the other of the guide head or receiving chamber. The key is slideably disposed in the keyway for transmitting rotary motion between the upper and lower steering shafts while permitting axially telescopic relative sliding motion there between so that the axial position of the steering wheel can be adjusted for maximum driver comfort.

According to a second aspect of the invention, a method for forming the telescopically adjustable vehicular steering column assembly is provided. The method comprises the steps of forming an axially extending receiving chamber in a lower tubular section of an upper steering shaft, forming a lower steering shaft, attaching a guide head to one end of the lower steering shaft, axially slideably positioning the guide head within the receiving chamber of the lower tubular section, simultaneously forming an axially extending keyway through the lower tubular section and into the guide head, positioning a key in the keyway, and fixing the key relative to the lower tubular section so that the key is slideable along the keyway in the guide head while transmitting rotary motion between the upper steering shaft and the lower steering shaft.

According to yet another aspect of the invention, a method for forming a telescopically adjustable vehicular steering column assembly is provided. The method comprises the steps of forming an axially extending receiving chamber in a lower tubular section of an upper steering shaft, forming a lower steering shaft, attaching a guide head to one end of the lower steering shaft, forming an axially extending keyway in the receiving chamber, affixing a key to the guide head, positioning the guide head within the receiving chamber of the lower tubular section with the key in sliding registry with the keyway, and creating a lower stop between the guide head and the receiving chamber to prevent disassembly of the lower steering shaft from the upper steering shaft.

A steering column assembly made according to the invention is particularly well-suited to creating a high precision design in which a telescoping steering shaft assembly is less costly to produce but at the same time is strong and exhibits good telescoping loads.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a fragmentary side view of a portion of a passenger vehicle with parts broken away to illustrate the general location and range of adjustable movement of a steering column assembly made in accordance with the invention;

FIG. 2 is a fragmentary perspective view of the lower steering shaft showing the guide head in a preassembly condition;

FIG. 3 is a side view, in partial cross-section, of the upper steering shaft;

FIG. 4 is a side view of the upper steering shaft as in FIG. 3, but showing the guide head positioned within the receiving chamber and an end mill simultaneously forming a keyway in the lower tubular section and the guide head;

FIG. 5 is a view as in FIG. 4 yet showing an alternative milling operation to simultaneously form the keyway in the lower tubular section and the guide head;

FIG. 6 is a fragmentary cross-sectional view of the upper steering shaft fully functionally assembled to the lower steering shaft;

FIG. 7 is a cross-sectional view taken along lines 7-7 of FIG. 6;

FIG. 8 is a cross-sectional view taken along lines 8-8 of FIG. 6;

FIG. 9 is a fragmentary perspective view of an alternative embodiment of the guide head fitted with a key and a delashing spring;

FIG. 10 is a fragmentary cross-sectional view of the alternative embodiment according to FIG. 9 in a fully functional assembled condition.

### DETAILED DESCRIPTION OF THE PREFERRED EMBODIMENT

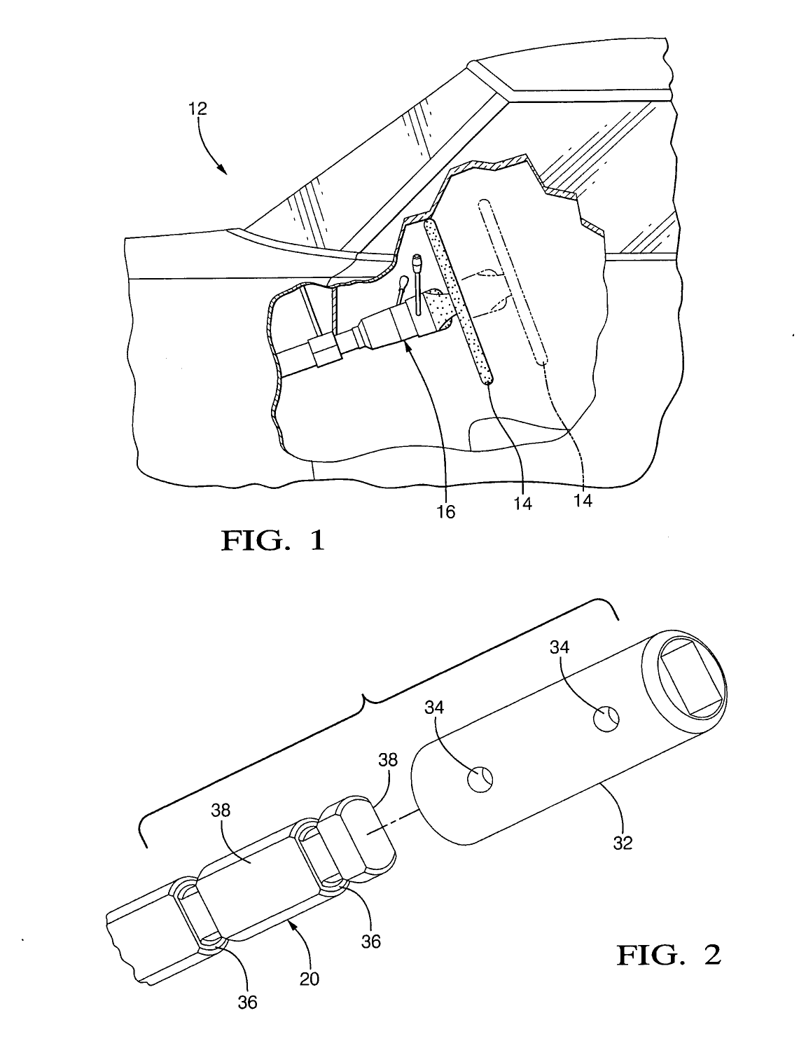

Referring to the Figures, wherein like numerals indicate like or corresponding parts throughout the several views, a portion of a conventional passenger automobile is generally shown at 12 in FIG. 1. Although the preferred application of the invention is within the field of automobiles 12 and other road vehicles, the invention can be practiced with equal affect in other vehicular fields, including marine and aeronautic applications, as well as non-vehicular fields. Referring again to FIG. 1, however, the automobile 12 is shown including a conventional steering wheel 14 supported at the end of a column assembly, generally indicated at 16. In order to accommodate personal preferences in the positioning of the steering wheel 14, the column assembly 16 is telescopically adjustable so that the steering wheel 14 can be moved to various axially adjusted positions. Although not a subject of this invention, the column assembly 16 can be further modified to provide angular adjustment of the steering wheel 14 through any of the know tilt adjust or rake adjust mechanisms.

The column assembly 16 functions to transmit rotary motion from the steering wheel 14 to the steered element which, in the case of an automobile 12, usually comprises the two front wheels. However, in marine applications, the steered element may include a rudder or articulated propulsion unit; in the case of aeronautical applications, the steered element may comprise a rudder or other features. Thus, the novel column assembly 16 can be deployed in any application in which a steering wheel 14 or other steering grip device is telescopically adjustable.

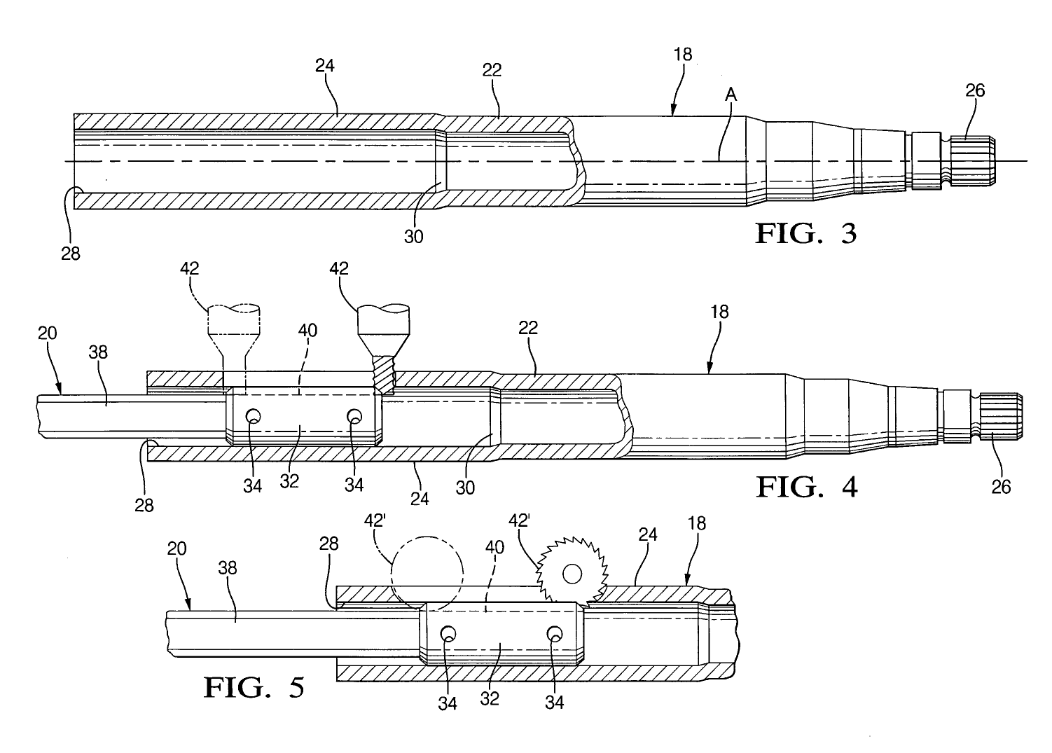

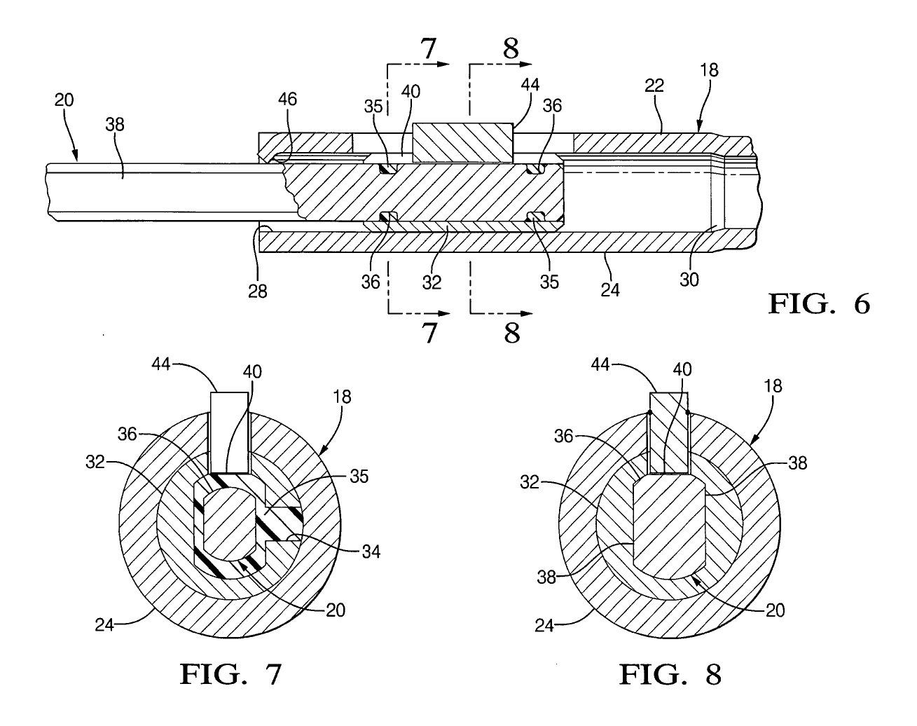

The column assembly 16 is comprised of an upper steering shaft, generally indicated at 18 and a lower steering shaft, generally indicated at 20. Preferably, although not necessarily, the upper steering shaft 18 is operatively connected to the steering wheel 14 while the lower steering shaft 20 is operatively connected (typically through additional controls or linkages) to the steered element. The upper 18 and lower 20 steering shafts are best shown in FIGS. 2 through 6, with the upper steering shaft defining a longitudinal axis A which is coincident with the turning axis of the steering wheel 14. The upper steering shaft 18 includes an upper tubular section 22 and a lower tubular section 24. A traditional coupling feature 26 is carried on the end of the upper tubular section 22 for attaching the steering wheel 14. The coupling feature may include splines and/or tapers, together with threaded fastening elements, to securely attach the steering wheel 14. The lower tubular section 24 presents, at its open end, an axially extending receiving chamber 28. The receiving chamber 28 is preferably formed in a precision machining operation which includes drilling, reaming, and honing to very precise tolerances for proper mating engagement with the lower steering shaft 20. The interface between the upper 22 and lower 24 tubular sections results in a narrowing of the interior region of the upper steering shaft 18 and forms an internal step 30 whose purpose is described below.

The lower steering shaft 20 includes a guide head 32 fixed thereto and axially slideably disposed within the receiving chamber of the lower tubular section 24. As perhaps best shown in FIG. 2, the guide head 32 is a generally tubular member which slips over the end of the lower steering shaft 20 and is secured with a plastic sheer material 35 introduced through side injection ports 34. The lower steering shaft 20 is preferably formed with a double “D” cross-section, such that a pair of opposing flats 38 interrupt an otherwise cylindrical exterior configuration. The guide head 32 is shaped to mate over the lower steering shaft 20 so that rotary motion can be transmitted directly between the two components. During the assembly process, when the guide head 32 is in position over the end of the lower steering shaft 20, the injection ports 34 align with injection grooves 36 machined into the lower steering shaft 20. Once the fluidic plastic material 35 has solidified, the guide head 32 is securely affixed in an operative position to the lower steering shaft 20. Like the receiving chamber 28, the guide head 32 is also precision machined to a surface finish and dimensional tolerance that allows a smooth axially slideable engagement into the receiving chamber 28.

Referring to FIG. 4, a further step in the assembly operation is illustrated by the simultaneous forming of an axially extending keyway 40 through the lower tubular section 24 and into the guide head 32. With the guide head 32 in a generally central position along the length of the receiving chamber 28, an end mill 42 is used to machine the keyway 40 so that its length traverses fully beyond the length of the guide head 32. This ensures a full running length of keyway 40 through the guide head 32. Once the keyway 40 has been thus formed, the end mill 42 is retracted and the components disassembled and deburred.

Those skilled in the art will appreciate that other machining techniques can be used to form the keyway 40. As one example of many possible alternatives, FIG. 5 illustrates a cutting wheel 42′ which can be used to form the keyway 40. The particular type of machining operation is not critical. By simultaneously forming the keyway 40 through both the lower tubular section 24 and the guide head 32 using the same cutting tool 42, the keyway 40 achieves exactly the same width in both parts.

After the deburring operation, the guide head 32 is reinserted into the receiving chamber 28 with a key 44 positioned within the keyway 40. By welding or other fixation technique, the key 44 is securely joined to the lower tubular section 24. Once the welding (or other fastening) operation is completed, the lower tubular section 24 is staked or otherwise modified on its distal, open end to create a lower stop 46 at the end of the keyway 40 to prevent disassembly. The internal step 30 forms an upper stop 30 and one limit of travel for the guide head 32 within the receiving chamber 28. Thus, during telescoping adjustment of the steering wheel 14, the upper steering shaft 18 collapses over the lower steering shaft 20 with a range of motion defined by the guide head 32 abutting either the upper stop 30 or the lower stop 46. All the while, the key 44 remains in registry with the keyway 40 in the guide head 32 which enables rotary motion to be transmitted between the upper steering shaft 18 and the lower steering shaft 20. A suitable clamping mechanism, not shown but of any conventional design, secures the upper steering shaft 18 in an adjusted position. Release of the clamping mechanism allows readjustment of the axial position of the steering wheel 14.

In the event of an overwhelming compressive force applied against the steering wheel 14, such as might occur in a collision, the column assembly 16 is designed to collapse in a controlled manner. In such an emergency, the upper steering shaft 18 will be compressed against the lower steering shaft 20. Assuming that the telescoping clamp mechanism has been overcome or released, the upper steering shaft 18 will continue sliding over the lower steering shaft 20 until the guide head 32 reaches the upper stop 30. At this point, an overwhelming force will cause the plastic material interconnecting the guide head 32 to the lower steering shaft 20 through the injection grooves 36 to sheer. At this catastrophic failure point, the lower steering shaft 20 may continue traveling into the hollow regions of the upper tubular section 22, i.e., past the upper stop 30, while the guide head 32 remains in the receiving chamber 28. During the series of events, external energy absorbing devices or other collision and safety mechanisms are deployed.

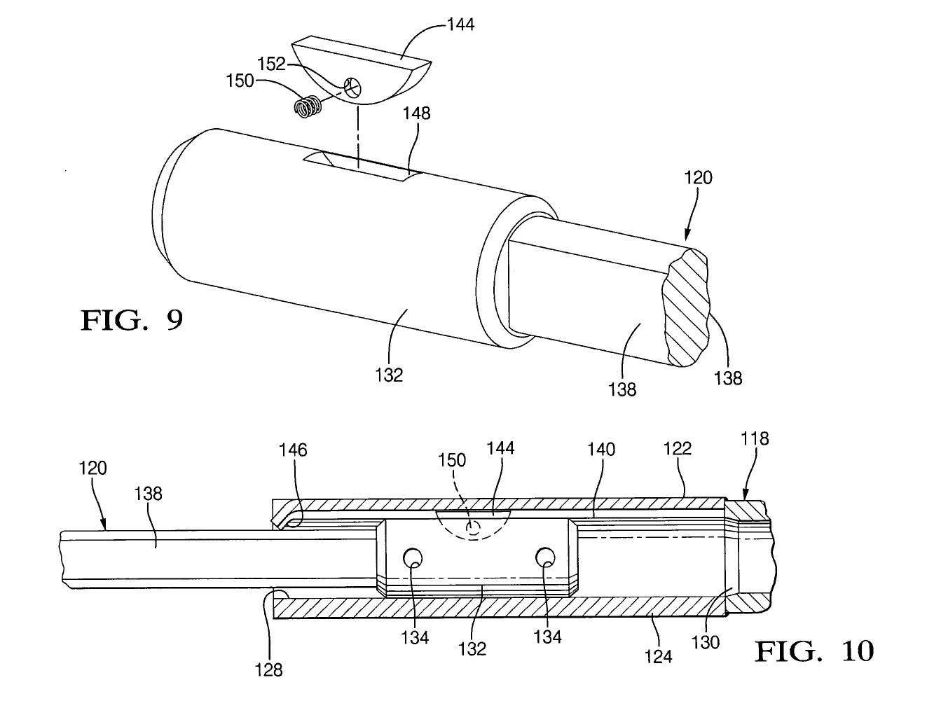

Referring now to FIGS. 9 through 10 an alternative configuration is described, with corresponding reference numbers being used in connection with the prefix “1”. This alternative design is characterized by the key 144 being fixed relative to the guide head 132 and slideable in a keyway 140 formed internally in the receiving chamber 128. Here, the guide head 132 includes a key slot 148 into which the key 144 is seated. A delashing spring 150 may be positioned between the key slot 148 and the key 144 to minimize torsional lash. Although the delashing spring 150 is shown for illustrative purposes as a compression spring seated in a pocket 152 in the side of the key 144, the delashing spring 150 may take alternative forms, including a formed leaf spring, a torsion spring, or any other type of biasing element.

The keyway 140 is finely machined into the receiving chamber 128 to provide appropriate sliding tolerances with the key 144. To facilitate formation of the keyway 140, the upper tubular section 122 can be formed separately from the lower tubular section 124, and the two components later joined in a subsequent operation to form the complete upper steering shaft 118. For example, the separately formed upper 122 and lower 124 tubular sections can be friction welded, traditionally welded, induction welded, threaded and pinned, or any other type of joining operation which does not interfere with the movement of the guide head 132 within the receiving chamber 128 to the full limits of the upper stop 130 nor of the necessary continued travel of the lower steering shaft 120 into the upper tubular section 122 in the event of a catastrophic event.

After installing the key 144 into the guide head 132 and inserting this subassembly into the lower tubular section 124, the receiving chamber 128 is staked at the end of the keyway 140 to prevent disassembly of the two components. Thus, like in the preceding embodiment, the alternative embodiment of FIGS. 9 and 10 functions to allow free telescoping movement of the upper steering shaft 118 relative to the lower steering shaft 120 while transmitting rotary motion therebetween.

A column assembly manufactured according to these designs and techniques is low in cost relative to existing designs, and at the same time is strong and exhibits good telescoping loads. The individual components are relatively easy to manufacture with relatively few surfaces requiring precision machining. The design also accommodates catastrophic impact scenarios in that once the guide head 32, 132 reaches the upper stop 30, 130, the injected plastic 35 sheers so that the lower steering shaft 20, 120 translates into the non-machine area of upper tubular section 22, 122.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A telescopically adjustable vehicular steering column assembly for transmitting rotary motion from a steering wheel to a steered element, said column assembly comprising:
an upper steering shaft defining a longitudinal axis and operatively connected to one of the steering wheel and the steered element, said upper steering shaft including a lower tubular section presenting an axially extending receiving chamber;
a lower steering shaft operatively connected to the other of the steering wheel and the steered element, said lower steering shaft including a guide head fixed thereto and axially sideably disposed within said receiving chamber of said lower tubular section;
an axially extending keyway formed in one of said guide head and said receiving chamber and a key fixed in the other of said guide head and said receiving chamber, said key slideably disposed in said keyway for transmitting rotary motion between said upper and lower steering shafts while permitting axially telescopic relative sliding motion therebetween to adjust the axial position of the steering wheel for maximum driver comfort.

2. The assembly as set forth in claim 1 further including a sheer member disposed between said guide head and said lower steering shaft.

3. The assembly as set forth in claim 2 wherein said sheer member comprises a plastic material.

4. The assembly as set forth in claim 2 wherein said guide head is generally tubular and surrounds said lower steering shaft.

5. The assembly as set forth in claim 4 wherein said guide head includes at least one injection port.

6. The assembly as set forth in claim 5 wherein said lower steering shaft includes at least one injection groove aligned with said injection port in said guide head.

7. The assembly as set forth in claim 4 wherein said lower steering shaft has a generally cylindrical exterior with at least one flat.

8. The assembly as set forth in claim 7 wherein said lower steering shaft has a pair of opposing flats.

9. The assembly as set forth in claim 4 wherein said upper steering shaft includes an upper tubular section coaxially extending from said lower tubular section, with the interface between said upper and lower tubular section defining an upper travel stop for said guide head.

10. The assembly as set forth in claim 9 wherein said lower tubular section includes a distal end opposite said upper travel stop, and a lower travel stop adjacent said distal end.

11. The assembly as set forth in claim 9 wherein said upper tubular section includes a hollow region having an internal diameter dimensioned to receive said lower steering shaft.

12. The assembly as set forth in claim 1 wherein said key is fixed relative to said upper steering shaft and slideable relative to said lower steering shaft and said guide head.

13. The assembly as set forth in claim 1 wherein said key is fixed relative to said lower steering shaft and slideable relative to said upper steering shaft.

14. The assembly as set forth in claim 13 further including a delashing spring disposed between said key and said guide head.

15. The assembly as set forth in claim 13 wherein said keyway extends the full length of said lower tubular section.

16. A method of forming a telescopically adjustable vehicular steering column assembly for transmitting rotary motion from a steering wheel to a steered element, said method comprising the steps of:
forming an axially extending receiving chamber in a lower tubular section of an upper steering shaft;
forming a lower steering shaft;
attaching a guide head to one end of the lower steering shaft;
axially slideably positioning the guide head within the receiving chamber of the lower tubular section;
simultaneously forming an axially extending keyway through the lower tubular section and into the guide head;
positioning a key in the keyway;
and fixing the key relative to the lower tubular section such that the key is slideable along the keyway in the guide head while transmitting rotary motion between the upper steering shaft and the lower steering shaft.

17. The method as set forth in claim 16 wherein said step of forming the keyway into the guide head includes forming the keyway the entire length of the guide head.

18. The method as set forth in claim 16 wherein said step of forming the receiving chamber includes a surface finishing operation.

19. The method as set forth in claim 16 wherein said step of attaching the guide head includes solidifying a fluidic material between the guide head and the lower steering shaft.

20. A method for forming a telescopically adjustable vehicular steering column assembly for transmitting rotary motion from a steering wheel to a steered element, said method comprising the steps of:
forming an axially extending receiving chamber in a lower tubular section of an upper steering shaft;
forming a lower steering shaft;
attaching a guide head to one end of the lower steering shaft;
forming an axially extending keyway in the receiving chamber;
affixing a key to the guide head;
axially sideably positioning the guide head within the receiving chamber of the lower tubular section with the key in sliding registry with the keyway;
and creating a lower stop between the guide head and the receiving chamber to prevent disassembly of the lower steering shaft from the upper steering shaft.

21. The method as set forth in claim 20 wherein said step of forming the keyway in the receiving chamber includes forming the keyway the entire length of the receiving chamber.

22. The method as set forth in claim 20 wherein said step of forming the receiving chamber includes a surface finishing operation.

23. The method as set forth in claim 20 wherein said step of attaching the guide head includes solidifying a fluidic material between the guide head and the lower steering shaft.

24. The method as set forth in claim 20 wherein said step of affixing the key to the guide head includes forming a key slot in the guide head.

25. The method as set forth in claim 24 wherein said step of affixing the key to the guide head includes positioning a delashing spring between the key slot and the key.
